(19) United States
(12) Patent Application Publication
(10) Pub. No.: US 2012/0003513 A1
(43) Pub. Date: Jan. 5, 2012

(54) BATTERY SYSTEM HAVING A CHAMBER CONTAINING INERT GAS

(75) Inventor: Jason Fuhr, Sussex, WI (US)

(73) Assignee: Johnson Controls - SAFT Advanced Power Solutions LLC

(21) Appl. No.: 13/182,316

(22) Filed: Jul. 13, 2011

Related U.S. Application Data
(63) Continuation of application No. PCT/US2010/021193, filed on Jan. 15, 2010.
(60) Provisional application No. 61/145,284, filed on Jan. 16, 2009.

(51) Int. Cl. H01M 2/12; H01M 10/04

(52) U.S. Cl. 429/53; 429/87; 29/623.1

(57) ABSTRACT

A battery module includes a plurality of electrochemical cells. Each cell includes a vent at an end of the cell. The battery module also includes a chamber adjacent the vents of the electrochemical cells. The battery module further includes an inert gas in the chamber for reducing the amount of oxygen present within the chamber.

### CROSS-REFERENCE TO RELATED PATENT APPLICATIONS

This application is a continuation of International Patent Application No. PCT/US2010/021193, filed Jan. 15, 2010, which claims the benefit of and priority to U.S. Provisional Patent Application No. 61/145,284, filed Jan. 16, 2009. The entire disclosures of International Patent Application No. PCT/US2010/021193 and U.S. Provisional Patent Application No. 61/145,284 are incorporated herein by reference.

### BACKGROUND

The present application relates generally to the field of batteries and battery systems. More specifically, the present application relates to batteries and battery systems that may be used in vehicle applications to provide at least a portion of the motive power for the vehicle.

Vehicles using electric power for all or a portion of their motive power (e.g., electric vehicles (EVs), hybrid electric vehicles (HEVs), plug-in hybrid electric vehicles (PHEVs), and the like, collectively referred to as “electric vehicles”) may provide a number of advantages as compared to more traditional gas-powered vehicles using internal combustion engines. For example, electric vehicles may produce fewer undesirable emission products and may exhibit greater fuel efficiency as compared to vehicles using internal combustion engines (and, in some cases, such vehicles may eliminate the use of gasoline entirely, as is the case of certain types of PHEVs).

As electric vehicle technology continues to evolve, there is a need to provide improved power sources (e.g., battery systems or modules) for such vehicles. For example, it is desirable to increase the distance that such vehicles may travel without the need to recharge the batteries. It is also desirable to improve the performance of such batteries and to reduce the cost associated with the battery systems.

One area of improvement that continues to develop is in the area of battery chemistry. Early electric vehicle systems employed nickel-metal-hydride (NiMH) batteries as a propulsion source. Over time, different additives and modifications have improved the performance, reliability, and utility of NiMH batteries.

More recently, manufacturers have begun to develop lithium-ion batteries that may be used in electric vehicles. There are several advantages associated with using lithium-ion batteries for vehicle applications. For example, lithium-ion batteries have a higher charge density and specific power than NiMH batteries. Stated another way, lithium-ion batteries may be smaller than NiMH batteries while storing the same amount of charge, which may allow for weight and space savings in the electric vehicle (or, alternatively, this feature may allow manufacturers to provide a greater amount of power for the vehicle without increasing the weight of the vehicle or the space taken up by the battery system).

It is generally known that lithium-ion batteries perform differently than NiMH batteries and may present design and engineering challenges that differ from those presented with NiMH battery technology. For example, lithium-ion batteries may be more susceptible to variations in battery temperature than comparable NiMH batteries, and thus systems may be used to regulate the temperatures of the lithium-ion batteries during vehicle operation. The manufacture of lithium-ion batteries also presents challenges unique to this battery chemistry, and new methods and systems are being developed to address such challenges.

It would be desirable to provide an improved battery module and/or system for use in electric vehicles that addresses one or more challenges associated with NiMH and/or lithium-ion battery systems used in such vehicles. It would also be desirable to provide a battery module and/or system that includes any one or more of the advantageous features that will be apparent from a review of the present disclosure.

### SUMMARY

According to an exemplary embodiment, a battery module includes a plurality of electrochemical cells. Each cell includes a vent at an end of the cell. The battery module also includes a chamber adjacent the vents of the electrochemical cells. The battery module further includes an inert gas in the chamber for reducing the amount of oxygen present within the chamber.

According to another exemplary embodiment, a battery module includes a plurality of electrochemical cells. Each cell comprising a vent at an end thereof, each vent configured to allow gas from within the cell to exit the cell. The battery module also includes a structure configured to receive the plurality of electrochemical cells so that the vent of each electrochemical cell is provided within a chamber defined by the structure. The battery module further includes an inert gas in the chamber for reducing the amount of oxygen present within the chamber.

According to another exemplary embodiment, a method for producing a battery module includes providing a plurality of electrochemical cells. Each cell includes a vent at an end of the cell. The method also includes providing a chamber adjacent the vents of the electrochemical cells. The method further includes providing an inert gas in the chamber to reduce the amount of oxygen present within the chamber such that when the vent deploys from one of the electrochemical cells the risk of a flame is reduced.

### BRIEF DESCRIPTION OF THE DRAWINGS

FIG. 1 is a perspective view of a vehicle including a battery module according to an exemplary embodiment.

FIG. 2 is a cutaway schematic view of a vehicle including a battery module according to an exemplary embodiment.

FIGS. 3-4 are partial cutaway views of a battery system according to an exemplary embodiment.

FIGS. 5-6 are perspective views of a portion of a battery module for use in a battery system according to an exemplary embodiment.

FIG. 7 is a partial exploded view of the battery module of FIG. 5.

FIG. 8 is a top view of the battery module of FIG. 5.

FIG. 9 is a cross-sectional view of a portion of the battery module of FIG. 8 taken along line 9-9 of FIG. 8.

FIG. 10 is a detail view of a portion of the battery module of FIG. 9.

FIG. 11 is a detail view of another portion of the battery module of FIG. 9.

FIG. 11A is a detail view of the portion of the battery module shown in FIG. 11 showing a vent in a deployed position according to an exemplary embodiment.

FIG. 12 is a detail view of the portion of the battery module shown in FIG. 11 showing an inert gas provided in a chamber of the battery module according to an exemplary embodiment.

FIG. 13 is a detail view of the portion of the battery module shown in FIG. 11 showing an inert gas provided in a sealed structure according to an exemplary embodiment.

FIG. 13A is a perspective view of the sealed structure of FIG. 13 according to one exemplary embodiment.

FIG. 13B is a perspective view of the sealed structure of FIG. 13 according to another exemplary embodiment.

FIG. 14 is a detail view of the portion of the battery module shown in FIG. 11 showing an inert gas provided in a sealed structure according to another exemplary embodiment.

FIG. 15A is a perspective view of the sealed structure of FIG. 14 according to one exemplary embodiment.

FIG. 15B is a top view of the sealed structure of FIG. 15A.

FIG. 16A is a perspective view of the sealed structure of FIG. 14 according to another exemplary embodiment.

FIG. 16B is a top view of the sealed structure of FIG. 16A.

### DETAILED DESCRIPTION

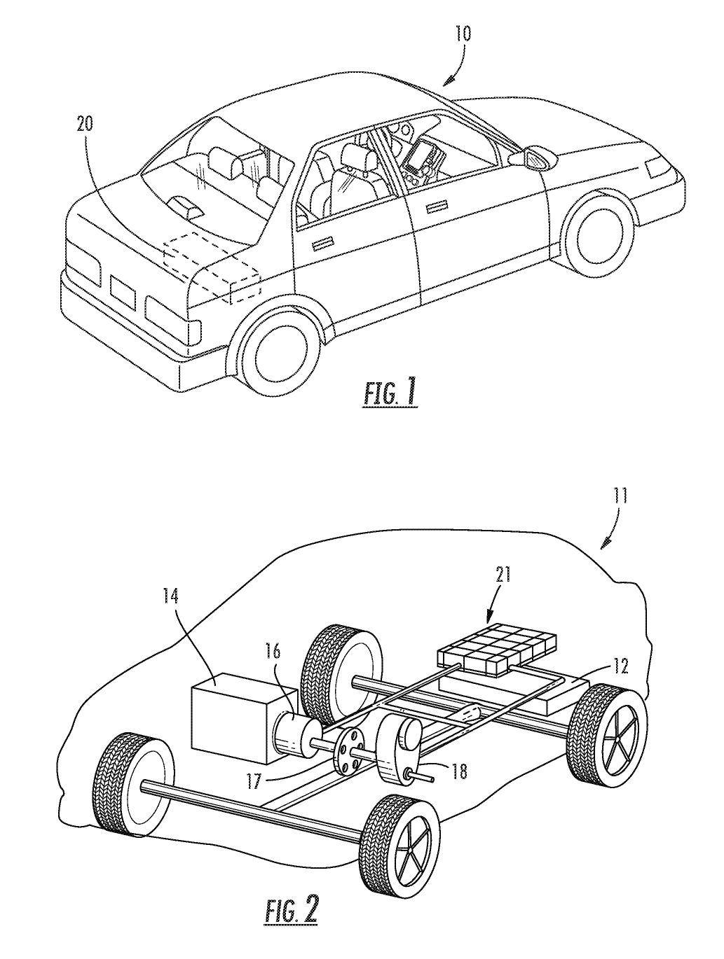

FIG. 1 is a perspective view of a vehicle 10 in the form of an automobile (e.g., a car) having a battery system 20 for providing all or a portion of the motive power for the vehicle 10. Such a vehicle 10 can be an electric vehicle (EV), a hybrid electric vehicle (HEV), a plug-in hybrid electric vehicle (PHEV), or other type of vehicle using electric power for propulsion (collectively referred to as “electric vehicles”).

Although the vehicle 10 is illustrated as a car in FIG. 1, the type of vehicle may differ according to other exemplary embodiments, all of which are intended to fall within the scope of the present disclosure. For example, the vehicle 10 may be a truck, bus, industrial vehicle, motorcycle, recreational vehicle, boat, or any other type of vehicle that may benefit from the use of electric power for all or a portion of its propulsion power.

Although the battery system 20 is illustrated in FIG. 1 as being positioned in the trunk or rear of the vehicle, according to other exemplary embodiments, the location of the battery system 20 may differ. For example, the position of the battery system 20 may be selected based on the available space within a vehicle, the desired weight balance of the vehicle, the location of other components used with the battery system 20 (e.g., battery management systems, vents, or cooling devices, etc.), and a variety of other considerations.

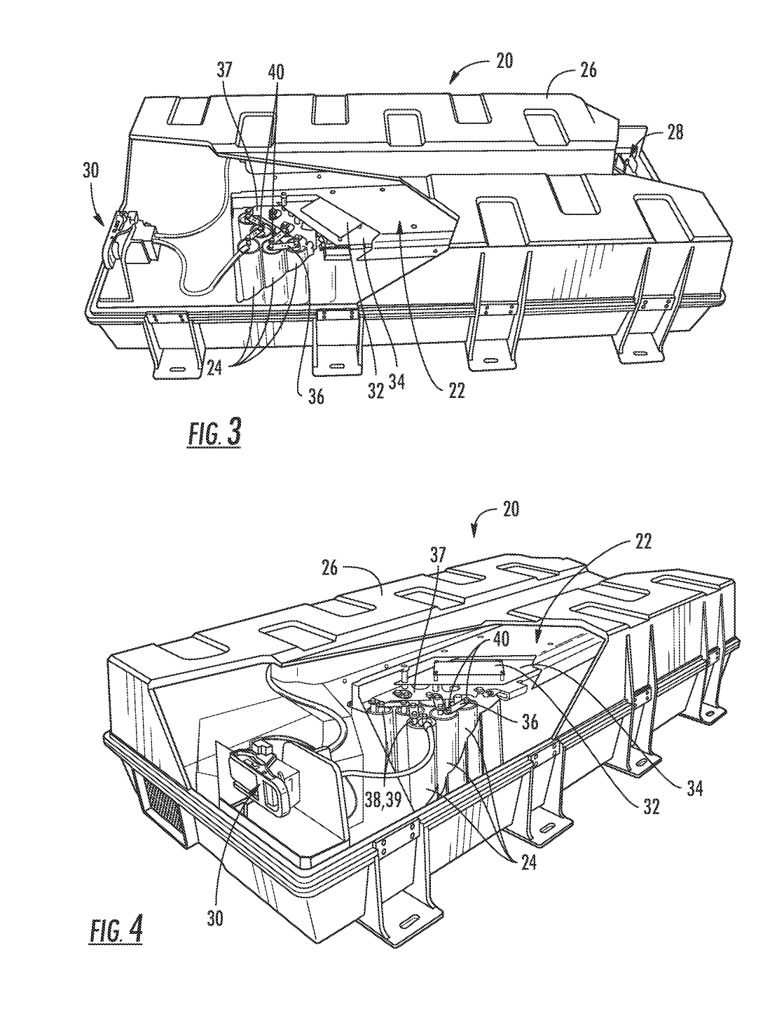

FIG. 2 illustrates a cutaway schematic view of a vehicle 11 provided in the form of an HEV according to an exemplary embodiment. A battery system 21 is provided toward the rear of the vehicle 11 proximate a fuel tank 12 (the battery system 21 may be provided immediately adjacent the fuel tank 12 or may be provided in a separate compartment in the rear of the vehicle 11 (e.g., a trunk) or may be provided elsewhere in the vehicle 11). An internal combustion engine 14 is provided for times when the vehicle 11 utilizes gasoline power to propel the vehicle 11. An electric motor 16, a power split device 17, and a generator 18 are also provided as part of the vehicle drive system.

Such a vehicle 11 may be powered or driven by just the battery system 21, by just the engine 14, or by both the battery system 21 and the engine 14. It should be noted that other types of vehicles and configurations for the vehicle drive system may be used according to other exemplary embodiments, and that the schematic illustration of FIG. 2 should not be considered to limit the scope of the subject matter described in the present application.

According to various exemplary embodiments, the size, shape, and location of the battery systems 20, 21, the type of vehicles 10, 11, the type of vehicle technology (e.g., EV, HEV, PHEV, etc.), and the battery chemistry, among other features, may differ from those shown or described.

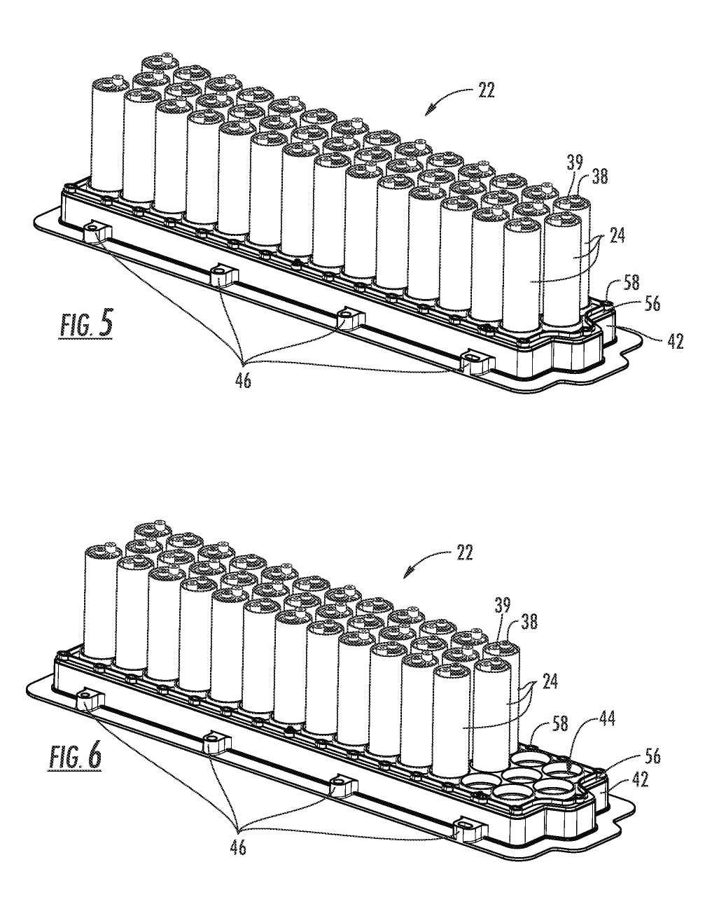

Referring now to FIGS. 3-4, partial cutaway views of a battery system 20 are shown according to an exemplary embodiment. According to an exemplary embodiment, the battery system 20 is responsible for packaging or containing electrochemical batteries or cells 24, connecting the electrochemical cells 24 to each other and/or to other components of the vehicle electrical system, and regulating the electrochemical cells 24 and other features of the battery system 20. For example, the battery system 20 may include features that are responsible for monitoring and controlling the electrical performance of the battery system 20, managing the thermal behavior of the battery system 20, containing and/or routing of effluent (e.g., gases that may be vented from a cell 24), and other aspects of the battery system 20.

According to the exemplary embodiment as shown in FIGS. 3-4, the battery system 20 includes a cover or housing 26 that encloses the components of the battery system 20. Included in the battery system are two battery modules 22 located side-by-side inside the housing 26. According to other exemplary embodiments, a different number of battery modules 22 may be included in the battery system 20, depending on the desired power and other characteristics of the battery system 20. According to other exemplary embodiments, the battery modules 22 may be located in a configuration other than side-by-side (e.g., end-to-end, etc.).

As shown in FIGS. 3-4, the battery system 20 also includes a high voltage connector 28 located at one end of the battery system 20 and a service disconnect 30 located at a second end of the battery system 20 opposite the first end according to an exemplary embodiment. The high voltage connector 28 connects the battery system 20 to a vehicle 10. The service disconnect 30, when actuated by a user, disconnects the two individual battery modules 22 from one another, thus lowering the overall voltage potential of the battery system 20 by half to allow the user to service the battery system 20.

According to an exemplary embodiment, each battery module 22 includes a plurality of cell supervisory controllers (CSCs) 32 to monitor and regulate the electrochemical cells 24 as needed. According to other various exemplary embodiments, the number of CSCs 32 may differ. The CSCs 32 are mounted on a member shown as a trace board 34 (e.g., a printed circuit board). The trace board 34 includes the necessary wiring to connect the CSCs 32 to the individual electrochemical cells 24 and to connect the CSCs 32 to the battery management system (not shown) of the battery system 20. The trace board 34 also includes various connectors to make these connections possible (e.g., temperature connectors, electrical connectors, voltage connectors, etc.).

Still referring to FIGS. 3-4, each of the battery modules 22 includes a plurality of electrochemical cells 24 (e.g., lithium-ion cells, lithium polymer cells, nickel-metal-hydride cells, etc., or other types of electrochemical cells now known or hereafter developed). According to an exemplary embodiment, the electrochemical cells 24 are generally cylindrical lithium-ion cells configured to store an electrical charge. According to other exemplary embodiments, the electrochemical cells 24 could have other physical configurations (e.g., oval, prismatic, polygonal, etc.). The capacity, size, design, and other features of the electrochemical cells 24 may also differ from those shown according to other exemplary embodiments.

Each of the electrochemical cells 24 are electrically coupled to one or more other electrochemical cells 24 or other components of the battery system 20 using connectors provided in the form of bus bars 36 or similar elements. According to an exemplary embodiment, the bus bars 36 are housed or contained in bus bar holders 37. According to an exemplary embodiment, the bus bars 36 are constructed from a conductive material such as copper (or copper alloy), aluminum (or aluminum alloy), or other suitable material. According to an exemplary embodiment, the bus bars 36 may be coupled to terminals 38, 39 of the electrochemical cells 24 by welding (e.g., resistance welding) or through the use of fasteners 40 (e.g., a bolt or screw may be received in a hole at an end of the bus bar 36 and screwed into a threaded hole in the terminal 38, 39).

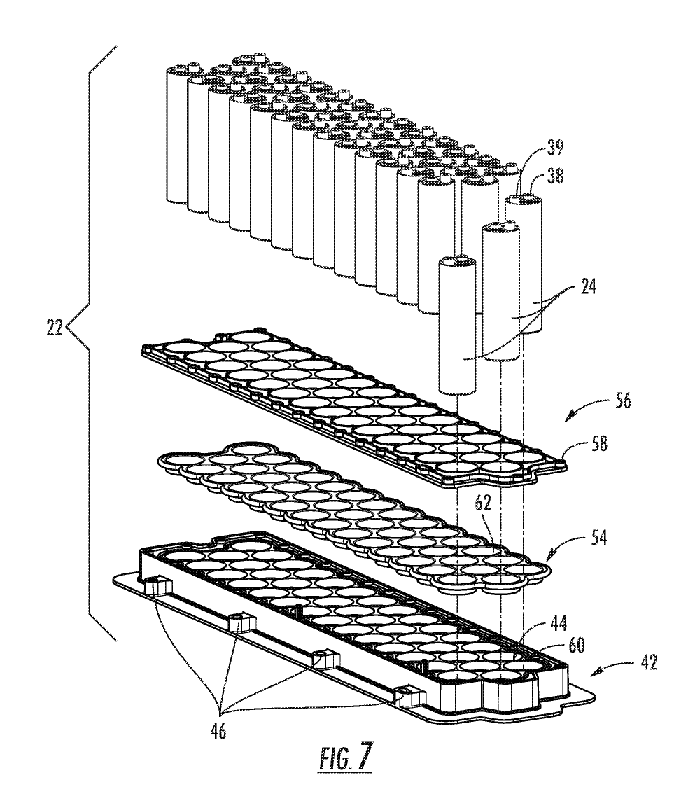

Referring now to FIGS. 5-11, a portion of a battery module 22 for use in a battery system 20 is shown according to an exemplary embodiment. The battery module 22 includes a plurality of electrochemical cells 24 provided in a first member or tray 42 (e.g., structure, housing, etc.). Although illustrated in FIG. 5 as having a particular number of electrochemical cells 24 (i.e., three rows of electrochemical cells arranged such that 14 electrochemical cells are arranged in each row, for a total of 42 electrochemical cells), it should be noted that according to other exemplary embodiments, a different number and/or arrangement of electrochemical cells 24 may be used in the battery module 22 depending on any of a variety of considerations (e.g., the desired power for the battery module 22, the available space within which the battery module 22 must fit, etc.).

According to an exemplary embodiment, the tray 42 receives the individual electrochemical cells 24 in the proper orientation for assembling the battery module 22. According to an exemplary embodiment, the tray 42 may also include features to provide spacing of the cells away from the bottom of the tray and/or from adjacent cells. For example, according to an exemplary embodiment, the trays may include a series of features shown as sockets 44 (e.g., openings, apertures, etc.) to locate and hold the electrochemical cells 24 in position above the bottom of the tray 42.

As shown in FIGS. 5-8, according to another exemplary embodiment, the tray 42 may also include features shown as bosses 46 that are intended to aid in the retention of a housing or cover (not shown) to enclose and/or retain the plurality of cells 24. According to another exemplary embodiment, the bosses 46 may also aid in securing the tray 42 to the vehicle or to other components of a battery system. According to an exemplary embodiment, the tray 42 may be made of a polymeric material or other suitable material (e.g., electrically insulated material).

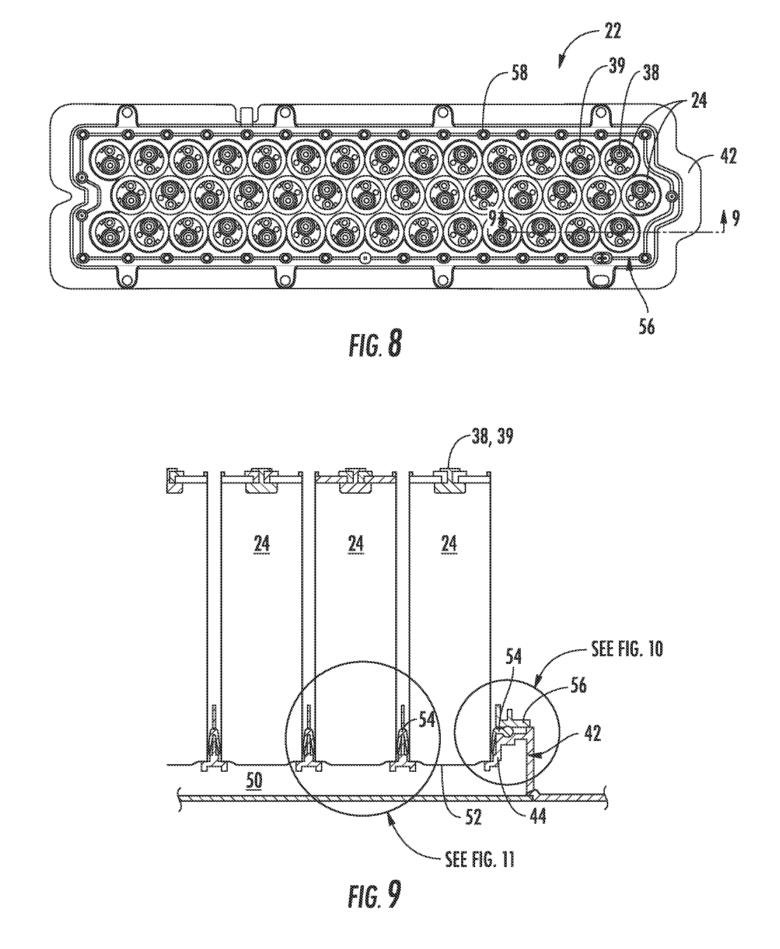

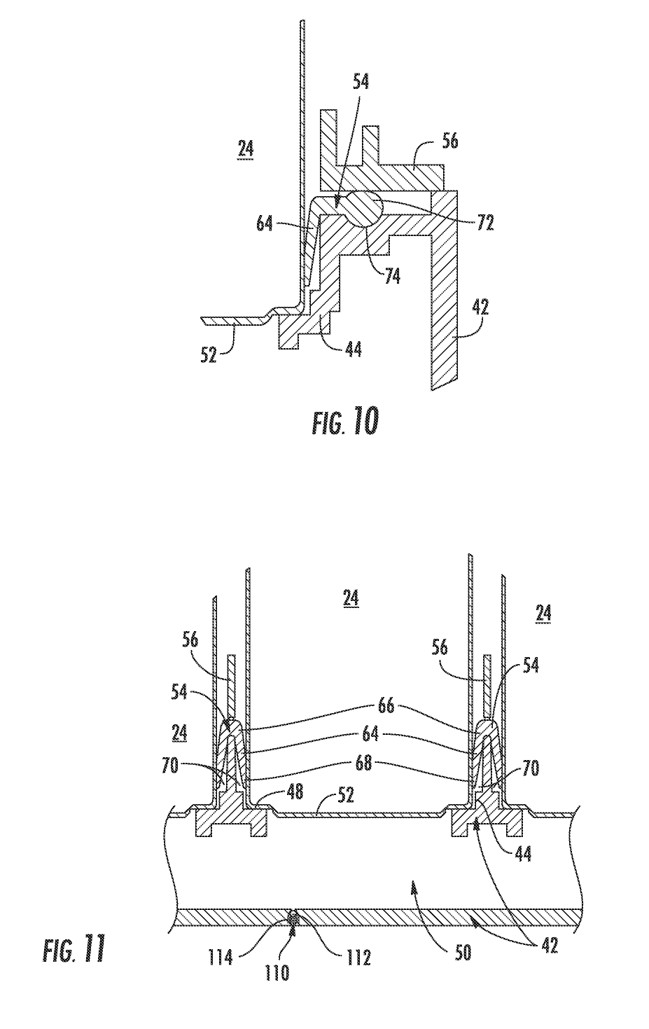

According to an exemplary embodiment, the sockets 44 of the tray 42 are configured to receive (e.g., retain, hold, position, etc.) a lower end or portion of the individual electrochemical cells 24. According to an exemplary embodiment, the sockets 44 are generally cylindrical openings having at least one step or surface 48 (e.g., as shown in FIG. 10) configured to engage or receive the lower portion of the electrochemical cell 24. According to other exemplary embodiments, the openings of the sockets 44 may have other shapes to receive cells of different shapes (e.g., prismatic, oval, etc.). The lower steps or surface 48 of the socket 44 positions the electrochemical cell 24 at a top portion of an airspace or chamber 50 defined by the tray 42 (e.g., as shown in FIG. 9). The chamber 50 is configured to receive gases and/or effluent that may be vented by the electrochemical cells 24 through a vent feature or vent device (e.g., vent 52 as shown in FIGS. 11-11A) of the electrochemical cell 24.

Referring now to FIGS. 7-9, the battery module 22 may also include a member shown as a gasket or seal 54. According to an exemplary embodiment, the seal 54 is configured to aid in sealing the lower portions of the electrochemical cells 24 in the tray 42 to help retain any gases vented from the electrochemical cells 24 into the chamber 50. According to an exemplary embodiment, the seal 54 is provided adjacent a top surface of the tray 42. According to an exemplary embodiment, the seal 54 may be constructed from a pliable, non-conductive material (e.g., such as silicone, rubber, etc.). According to one exemplary embodiment, the seal 54 may be die cut from a silicone sheet or other suitable material. According to another exemplary embodiment, the seal 54 may be a molded member (e.g., made by an injection molding process), such as a silicone molded member.

According to an exemplary embodiment, a member (fixture, device, plate, retainer, etc.) shown as a clamping plate 56 may be provided above the seal 54 in order to keep the seal 54 in place in relation to the tray 42. The clamping plate 56 may be coupled to the tray 42, for example, by threaded fasteners (not shown) that extend through holes 58 in the clamping plate 56 and are received by threaded holes 60 in the tray 42. According to another exemplary embodiment, the clamping plate 56 may be coupled to the tray 42 via a snap fit.

Referring now to FIGS. 10-11, according to an exemplary embodiment, the seal 54 includes a plurality of openings 62 that align with the plurality of sockets 44 of the tray 42. Each of the openings 62 of the seal 54 comprise a lip portion or edge portion 64 (e.g., a deformable extension) provided in contact with an electrochemical cell 24. According to an exemplary embodiment, the edge portion 64 of the seal 54 is angled in toward the electrochemical cell 24 to provide an interference fit with the electrochemical cell 24 in order to aid in sealing the chamber 50.

According to an exemplary embodiment, the edge portion 64 of the seal 54 is thinner than the rest of the seal 54, giving the edge portion flexibility to conform to the outer diameter of the electrochemical cell 24 in order to aid in sealing in the electrochemical cell 24. According to another exemplary embodiment, the edge portion 64 of the seal 54 is tapered (e.g., as shown in FIG. 11) from the main portion 66 of the seal 54 down to the tip 68 of the edge portion 64. This taper aids in giving the edge portion 64 the flexibility to conform to the outer diameter of the electrochemical cell 24 but still maintain the strength to allow the edge portion 64 to keep its shape over time (e.g., to minimize creep and relaxation of the seal 54 to maintain the interference fit with the electrochemical cell 24).

According to an exemplary embodiment, a space 70 is provided between the edge portion 64 of the seal 54 and each socket 44 of the tray 42 (e.g., as shown in FIG. 11). The space 70 is connected (e.g., in fluid communication) with the chamber 50 such that when gases are vented into the chamber 50 the gases may enter the space 70 (e.g., by slipping past the bottom of the electrochemical cell 24 and the socket 44). According to an exemplary embodiment, the vented gases press the seal 54 tighter against the electrochemical cell 24 to increase the sealing characteristics of the seal 54.

As shown in FIG. 10, the seal 54 includes an enlarged portion 72 (segment, section, ring, bulb, etc.) provided in a trough or groove 74 of the upper surface of the tray 42. When the enlarged portion 72 of the seal 54 is held in place by the clamping plate 56, the enlarged portion 72 of the seal 54 has several points of contact between the clamping plate 56 and/or the tray 42. According to an exemplary embodiment, a top of the enlarged portion 72 of the seal 54 has a single contact point with the clamping plate 56. According to another exemplary embodiment, the lower side of the enlarged portion 72 of the seal 54 has two contact points with the tray 42. According to another exemplary embodiment, the enlarged portion 72 of the seal 54 is compressed between the clamping plate 56 and the upper surface of the tray 42 so that the enlarged portion 72 of the seal 54 has a continuous line of contact with the clamping plate 56 and with the upper surface of the tray 42.

These multiple points and/or lines of contact aid in sealing (i.e., confining) vented gases in the chamber and do not allow the gases that have reached the space 70 in between the tray 42 and the edge portion 64 of the seal 54 to leak past. According to an exemplary embodiment, the enlarged portion 72 of the seal 54 may be located along a perimeter of the seal 54 (e.g., as shown in FIG. 7).

Referring now to FIGS. 11-14, the electrochemical cell 24 is shown having a vent 52. The vent 52 (e.g., a pressure relief device or region, etc.) provides a pressure relief mechanism for the electrochemical cell 24 that allows a controlled release of pressure and gas from inside the cell 24. According to an exemplary embodiment, the vent 52 comprises a member or element (e.g., vent disk) that is configured to deploy or separate from the electrochemical cell 24 by “breaking away” from the housing of the electrochemical cell 24 at a weakened area (e.g., a fracture point or groove) if the pressure inside the electrochemical cell 24 increases above a predetermined point. According to other exemplary embodiments, other types of vents may be used (e.g., vents that don't use a fracture point, such as, e.g., a pressure relief valve). As the vent 52 deploys, gases and/or effluent are released from inside the housing of the electrochemical cell 24 and enter the chamber 50.

When the vent 52 deploys (e.g., as shown in FIG. 11A), gases and/or effluent are allowed to exit the electrochemical cell 24 and enter the chamber 50, raising the pressure inside the chamber 50. In some instances, once the gases have entered the chamber 50, the gases may leak past the bottom of the electrochemical cell 24 and the tray 42. These gases may then enter the space 70 provided between the seal 54 and the tray 42. When the vented gases enter this space 70, the seal 54 is moved (compressed, deformed, etc.) upward and pressed against the electrochemical cell 24 in order to create a tighter seal. This is due to the fact that the pressure inside the space 70 behind the seal 54 (and in the chamber 50) is greater than the pressure above the seal 54.

Still referring to FIGS. 11-14, the chamber 50 (e.g., space, plenum, cavity, hollow, compartment, etc.) is provided in fluid communication with the electrochemical cells 24 and is configured to receive any gases and/or effluent released from the cells 24 (e.g., via the vent 52). The chamber 50 is also configured to isolate the vented gases from the vehicle cabin. According to an exemplary embodiment, the chamber 50 is configured to direct the gases to the exterior environment (e.g., outside the vehicle).

The vented gases from the electrochemical cells 24 may include flammable compounds that may react with oxygen (e.g., oxygen in atmospheric air) to produce a flame under certain circumstances. To reduce the chance of a flame occurring, a substance, material, or matter (e.g., a gas, liquid, or solid) may be provided in the chamber 50 to displace the oxygen that would otherwise be in the chamber 50. By displacing the oxygen, the vented gases will not mix with (and will not potentially react with) the oxygen.

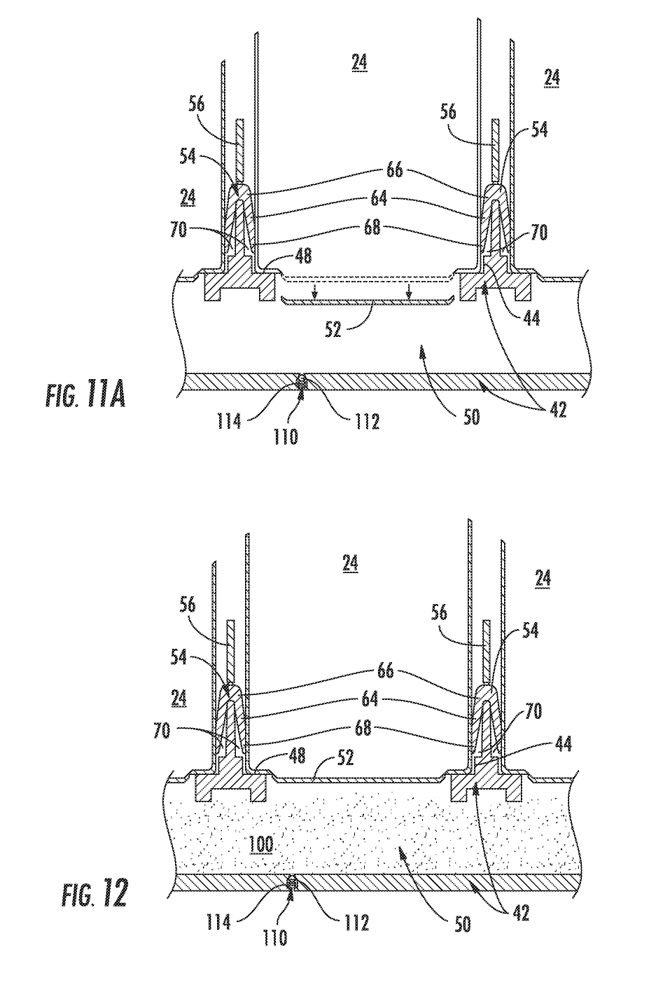

According to one exemplary embodiment, the oxygen displacing material is an inert gas (shown generally by reference number 100 in FIGS. 12-16B). Because the inert gas 100 is not reactive (under normal circumstances), the chances of a flame are reduced. Additionally, because the vented gases are allowed to expand when exiting the electrochemical cell 24 and entering the chamber 50, the vented gases are allowed to cool. Further, by allowing the vented gases to mix with the inert gas 100 (which is at a lower temperature than the vented gases), the vented gases are allowed to cool even more, thus further reducing the chance of a flame.

According to one exemplary embodiment, the inert gas 100 is argon. However, according to other exemplary embodiments, the inert gas 100 may be any elemental or molecular gas that is not reactive under normal circumstances (such as, e.g., helium, neon, krypton, xenon, radon, etc.). According to another exemplary embodiment, the oxygen displacing material may be a non-flammable foam or other suitable substance that is non-reactive with the gases and/or effluent that may be vented from the electrochemical cells 24. According to an exemplary embodiment, the non-flammable foam may be a hard or soft foam.

As shown in FIGS. 11-14, according to an exemplary embodiment, the seal 54 is provided between the cells 24 and the tray 42 of the housing of the battery module 22 so that the chamber 50 is substantially sealed from the rest of the battery module 22. A valve (such as, e.g., check valve 110 as shown in FIGS. 11-14) may be provided in a portion of the housing (e.g., the tray 42) forming the chamber 50. The check valve 110 includes a member or ball 112 and a biasing element or spring 114 to bias (e.g., force) the ball 112 into an opening of the check valve 110 to close the check valve 110.

When the vented gases exit the electrochemical cell 24 and enter the chamber 50, the pressure in the chamber 50 increases. The higher pressure causes the check valve 110 to open (e.g., the force of the spring 114 is overcome) and the vented gases are allowed to exit to the exterior environment through the check valve 110. The check valve 110, however, prevents outside air (e.g., including oxygen) from flowing into the chamber 50. By allowing the vented gases to mix with the inert gas 100 before exiting the chamber 50 through the check valve 110, the vented gases are allowed to cool. This reduces the chance of a flame once the vented gases exit the chamber 50 to the exterior environment through the check valve 110.

As shown in FIG. 12, according to an exemplary embodiment, the chamber 50 is filled with an inert gas 100 (e.g., through a port or opening (not shown)) to displace atmospheric air containing oxygen that would otherwise be in the chamber 50. In this embodiment, the chamber 50 is configured to retain the inert gas 100 inside the chamber 50 during operation of the battery module 22. Upon deployment of a vent 52 of one of the electrochemical cells 24, the gases and/or effluent that is released from the electrochemical cell 24 is allowed to mix with the inert gas 100 in the chamber 50. The battery module 22 may include a valve (e.g., such as check valve 110 as described above) to allow the vented gases and/or effluent (along with the inert gas) to exit the chamber 50.

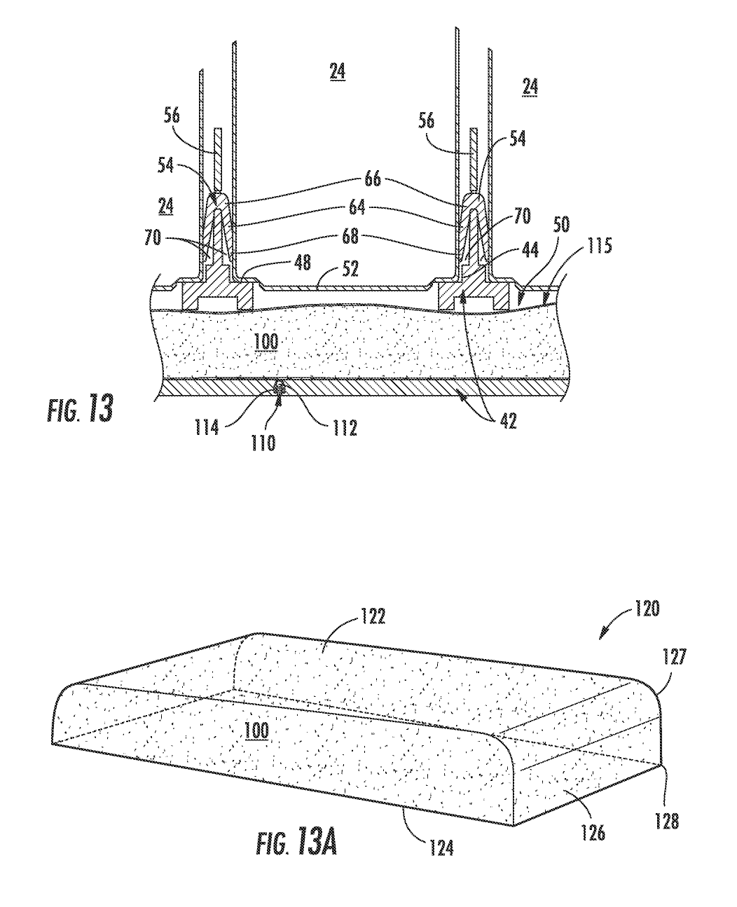

According to another exemplary embodiment, a sealed structure filled with inert gas 100 is provided in the chamber 50 (such as, e.g., sealed structures 115, 120, 130, 140, 150, 160 as shown in FIGS. 13-16B, respectively). The inert gas 100 is provided in the sealed structure to reduce the risk that the inert gas 100 may leak out of the chamber 50 (and allow oxygen to enter the chamber 50).

The sealed structure may, for example, be formed from a polymer film material (such as, e.g., polyethylene, polypropylene, etc.) that forms one sealed pocket (e.g., as shown in FIGS. 13-13B) or multiple sealed pockets or bubbles (e.g., as shown in FIGS. 14-16B). According to an exemplary embodiment, the polymer film material is relatively thin. For example, the polymer film material may have a thickness between approximately 1 and 2 micrometers. However, according to other exemplary embodiments, the polymer film material may have a greater or lesser thickness. According to another exemplary embodiment, the sealed structure may be formed from a polymer laminated metal foil (e.g., similar to a potato chip bag).

Upon deployment of the vent 52, the gases that are vented from the electrochemical cells 24 are at a temperature that is high enough to melt the material that forms the sealed structure shown in FIGS. 13-16A. As the material melts, the sealed pocket(s) are ruptured and the inert gas 100 is released into the chamber 50 to mix with and cool the vented gases. Such a chamber 50 may also include a check valve 110 (as described above) to allow the inert gas 100 and vented gases to exit the chamber 50 to the exterior environment.

According to an exemplary embodiment, the sealed structure containing the inert gas 100 is configured to substantially fill the chamber 50, thus displacing a substantial amount of oxygen that may have otherwise been present in the chamber 50 (e.g., as shown in FIG. 13). According to an exemplary embodiment, there may be a clearance space (e.g., as shown in FIG. 13) between the top of the sealed structure and the vent 52 of the electrochemical cell 24 to allow for the vent 52 to properly deploy. According to one embodiment, the clearance space has a height of approximately 3 and 4 millimeters, but may have a greater or lesser height according to other exemplary embodiments.

According to another exemplary embodiment (not shown), the sealed structure may be provided so that it is substantially adjacent the vent 52 (e.g., the sealed structure may butt up against the vent). In this case, the sealed structure would contain the inert gas 100 at a relatively low pressure (i.e., the sealed structure has a high amount of give) in order for the vent 52 to move the sealed structure out of the way during deployment of the vent 52.

Specific examples of sealed structures (as shown in FIGS. 13A-13B and 15A-16B) will now be described in more detail. It should be noted that one of ordinary skill in the art will readily recognize that many more shapes, sizes, and configurations of sealed structures are possible than shown in the FIGURES.

As shown in FIG. 13A, the sealed structure 120 is shown according to an exemplary embodiment. The sealed structure 120 is shown to include a top portion 122, a bottom portion 124, and side walls 126 that connect the top portion 122 to the bottom portion 124. According to an exemplary embodiment, the side walls 126 may be connected to the top and bottom portions 122, 124 with either a rounded corner or a straight corner (e.g., such as rounded corner 127 or straight corner 128 as shown in FIG. 13A).

As shown in FIG. 13B, the sealed structure 130 is shown according to an exemplary embodiment. The sealed structure 130 includes a top portion 132 and a bottom portion 134. The top and bottom portions 132, 134 are connected to one another at a seam 136. According to an exemplary embodiment, the inert gas 100 is provided inside the sealed structure 130 prior to coupling (e.g., welding) the top and bottom portions 132, 134 together at the seam 136.

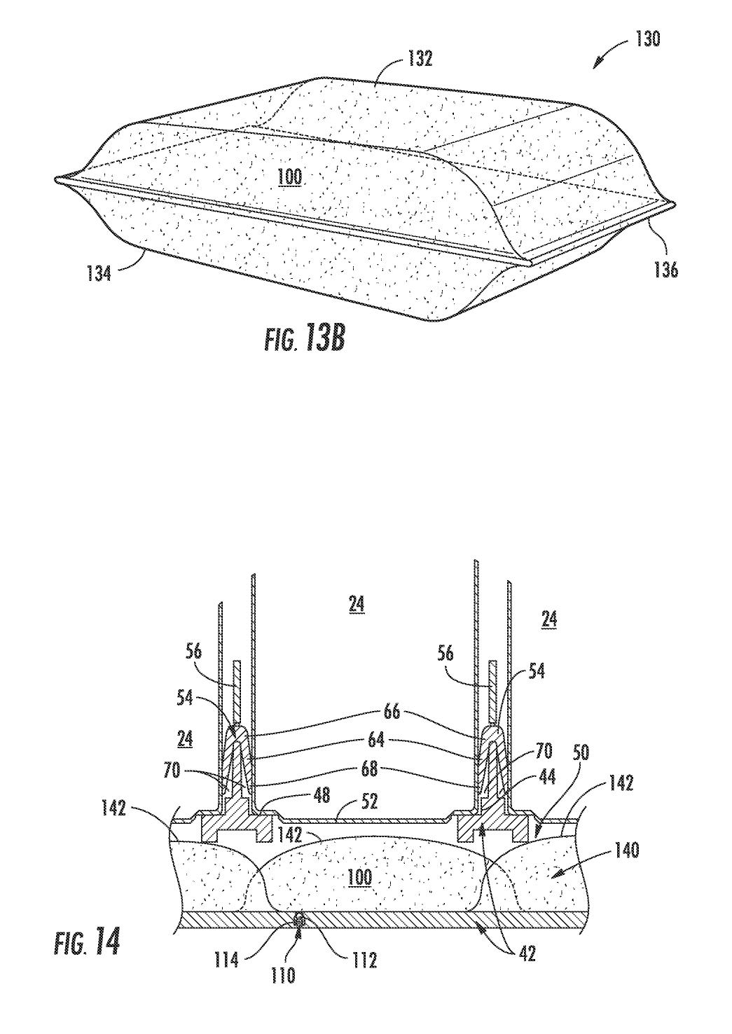

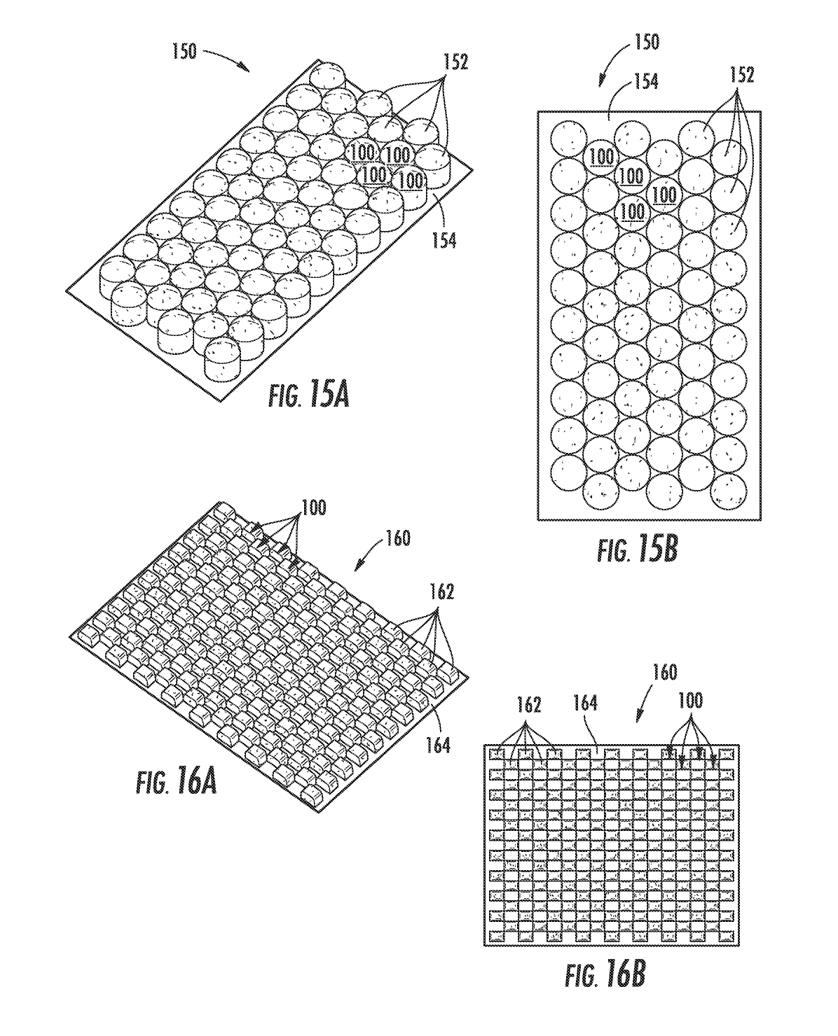

As shown in FIGS. 15A-15B, the sealed structure 150 is shown according to an exemplary embodiment. The sealed structure 150 includes a plurality of sealed pockets or bubbles 152 provided on a base member 154. According to one exemplary embodiment, the base member 154 forms a bottom portion of each of the sealed pockets 152. According to an exemplary embodiment, each of the sealed pockets 152 contains inert gas 100.

According to an exemplary embodiment, each of the sealed pockets 152 has a generally cylindrical or dome shape (e.g., similar to bubble wrap used in the packing and shipping industry). The multiple sealed pockets 152 are provided in close proximately to one another to decrease the amount of oxygen that is present in the chamber 50 once the sealed structure 150 is placed in the chamber 50. According to one exemplary embodiment, the sealed pockets 152 are provided adjacent one another such that each of the sealed pockets 152 is in contact with another sealed pocket 152. However, according to other exemplary embodiments, the sealed pockets 152 may be provided such that they are not in contact with one another.

As shown in FIGS. 16A-16B, the sealed structure 160 is shown according to an exemplary embodiment. The sealed structure 160 includes a plurality of sealed pockets or bubbles 162 provided on a base member 164. According to one exemplary embodiment, the base member 164 forms a bottom portion of each of the sealed pockets 162. According to an exemplary embodiment, each of the sealed pockets 162 contains inert gas 100.

According to an exemplary embodiment, each of the sealed pockets 162 has a generally rectangular or prismatic shape. Additionally, each of the sealed pockets 162 has a rounded top portion, but may have other configurations according to other exemplary embodiments. The multiple sealed pockets 162 are provided in close proximately to one another to decrease the amount of oxygen that is present in the chamber 50 once the sealed structure 160 is placed in the chamber 50. According to one exemplary embodiment, the sealed pockets 162 are provided adjacent one another in an alternating fashion such that a corner or edge of each of the sealed pockets 162 is in contact with a corner or edge of another sealed pocket 162. However, according to other exemplary embodiments, the sealed pockets 162 may be provided such that they are not in contact with one another.

One exemplary embodiment relates to a method that includes providing a battery module having at least one cell and a chamber adjacent an end of the cell. An inert gas is provided in the chamber. The cell has a venting device configured to vent gases from the cell to the chamber. When the gases from the cell are vented to the chamber, the risk of a flame is reduced. The inert gas may be provided in a plastic or bubble wrap. When the gases are released from the cell, the gases are at a temperature high enough to melt the bubble wrap to release the inert gas.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure.

It is important to note that the construction and arrangement of the flame limiting vent chamber as shown in the various exemplary embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Other substitutions, modifications, changes and omissions may also be made in the design, operating conditions and arrangement of the various exemplary embodiments without departing from the scope of the present invention.

What is claimed is:

1. A battery module comprising:
a plurality of electrochemical cells, each cell comprising a vent at an end thereof;
a chamber adjacent the vents of the electrochemical cells; and
an inert gas in the chamber for reducing the amount of oxygen present within the chamber.

2. The battery module of claim 1, wherein the inert gas is selected from the group consisting of argon, helium, neon, krypton, xenon, and radon.

3. The battery module of claim 1, wherein the battery module comprises a seal for sealing the inert gas within the chamber.

4. The battery module of claim 1, wherein the inert gas is provided in a sealed structure that is located inside the chamber.

5. The battery module of claim 4, wherein the sealed structure comprises a structure at least partially formed of a polymeric material.

6. The battery module of claim 5, wherein the polymeric material is selected from the group consisting of polyethylene and polypropylene.

7. The battery module of claim 4, wherein the sealed structure comprises a plurality of sealed pockets.

8. The battery module of claim 7, wherein the plurality of sealed pockets are provided in close proximately to one another.

9. The battery module of claim 8, wherein at least a portion of one of the plurality of sealed pockets is in contact with at least a portion of another one of the plurality of sealed pockets.

10. The battery module of claim 7, wherein at least some of the plurality of sealed pockets have a generally prismatic shape.

11. The battery module of claim 7, wherein at least some of the plurality of sealed pockets have a generally cylindrical shape.

12. The battery module of claim 7, wherein at least some of the plurality of sealed pockets contain inert gas.

13. The battery module of claim 4, wherein any gases released from the electrochemical cells when the vent deploys are at a temperature sufficient to melt the sealed structure to release the inert gas within the chamber.

14. The battery module of claim 1, further comprising a valve for selectively allowing any gases released from the electrochemical cells to exit the chamber.

15. A battery module comprising:
a plurality of electrochemical cells, each cell comprising a vent at an end thereof, each vent configured to allow gas from within the cell to exit the cell;
a structure configured to receive the plurality of electrochemical cells so that the vent of each electrochemical cell is provided within a chamber defined by the structure; and
an inert gas in the chamber for reducing the amount of oxygen present within the chamber.

16. The battery module of claim 15, wherein the inert gas is provided in a sealed structure that is located inside the chamber.

17. The battery module of claim 16, wherein the sealed structure comprises a plurality of sealed pockets.

18. A method for producing a battery module comprising:
providing a plurality of electrochemical cells, each cell comprising a vent at an end thereof;
providing a chamber adjacent the vents of the electrochemical cells; and
providing an inert gas in the chamber to reduce the amount of oxygen present within the chamber such that when the vent deploys from one of the electrochemical cells the risk of a flame is reduced.

19. The method of claim 18, further comprising providing the inert gas in a sealed structure, wherein the sealed structure is located inside the chamber.

20. The method of claim 19, wherein the sealed structure comprises a plurality of sealed pockets.
